(19) United States
(12) Patent Application Publication
(10) Pub. No.: US 2024/0369216 A1
(43) Pub. Date: Nov. 7, 2024

(54) LIGHTING AND LIGHT MOUNTING SYSTEMS FOR A DRILLING RIG

(71) Applicant: Ensign Energy Services, Calgary (CA)

(72) Inventors: Jake Hamdan, Edmonton (CA); Robert H. Geddes, Calgary (CA)

(21) Appl. No.: 18/652,410

(22) Filed: May 1, 2024

Related U.S. Application Data
(60) Provisional application No. 63/463,440, filed on May 2, 2023.

(51) Int. Cl. F21V 33/00; F21S 8/08; F21V 21/088; F21V 21/30; F21W 131/10; F21W 131/402

(52) U.S. Cl. CPC F21V 33/00; F21S 8/086; F21V 21/088; F21V 21/30; F21W 2131/1005; F21W 2131/402

(57) ABSTRACT

A lighting system for a drilling rig includes a light attached to a light mounting system having an attachment mechanism and an adjustable attachment point. The attachment mechanism is configured to removably couple to a support structure of a drilling rig below the crown block. The attachment point optionally provides the light with a range of motion that includes an operating configuration and a stowed configuration.

### CROSS-REFERENCE TO RELATED APPLICATION(S)

This application claims the benefit under 35 U.S.C. § 119 (e) to U.S. Provisional Application 63/463,440, filed May 2, 2023, and entitled “Lighting and Light Mounting Systems for a Drilling Rig,” which is hereby incorporated herein by reference in its entirety.

### TECHNICAL FIELD

The disclosed technology relates generally to drilling rig lighting, and relates more particularly to light mounting systems for drilling rigs.

### BACKGROUND

A typical drilling rig includes a tall support structure that supports a hoisting system above a drilling site. A permanent or semi-permanent support structure that is assembled in stages is often referred to as a derrick. The term “mast” is often used to refer to a more portable structure that is assembled on the ground and then hoisted into place. In either case, the support structure usually extends high above the ground to provide clearance for moving long lengths of drill pipe, casings, and tubing into and/or out of the wellbore. The support structure is often formed in a pyramidal shape with steel support beams connected in a latticed or trussed arrangement extending up and down each of the four sides of the structure.

The hoisting system of a drilling rig includes a crown block of pulleys or sheaves and adjacent decking positioned at or near the top of the derrick or mast. The crown block works in combination with a traveling block and other parts to lower and raise drilling components at the drill site.

A drilling rig often includes lights for illuminating the drill site. In some cases lights are mounted at or near the top of a derrick or mast in order to provide illumination for a drill site. As an example, lights may be mounted on or above the crown block deck. While the height of such lights may be desirable, the crown block and adjacent deck can interfere with and/or block the lights from illuminating parts of the site below the crown block.

Accordingly, there is a need for improved lighting for a drilling rig.

### SUMMARY

According to a first aspect, the disclosed technology provides a lighting system for a drilling rig. The lighting system includes a light mounting system that has an attachment mechanism and an adjustable attachment point. The attachment mechanism is configured to removably couple to a support structure of a drilling rig below the crown block. The adjustable attachment point is coupled with the attachment mechanism. The system further includes a light attached to the adjustable attachment point.

In various implementations the lighting system includes one or more of the following features and/or aspects. In some cases the adjustable attachment point provides the light with a range of motion that includes an operating configuration and a stowed configuration. In some cases the light mounting system has multiple adjustable attachment points coupled to the attachment mechanism, and also includes multiple lights, with each light attached to one of the adjustable attachment points. In some cases the adjustable attachment points are arranged in a stacked configuration.

Another aspect of the disclosed technology provides a light mounting system for a drilling rig. The light mounting system includes an attachment mechanism configured to removably couple to a support structure of a drilling rig. The system also includes an adjustable attachment point coupled with the attachment mechanism. The adjustable attachment point is configured to attach to a light for positioning the light below the crown block of the drilling rig.

In various implementations the lighting mounting system includes one or more of the following features and/or aspects. In some cases the adjustable attachment point provides an attached light with a range of motion including an operating configuration and a stowed configuration. In some cases the mounting system includes multiple adjustable attachment points coupled to the attachment mechanism. Each adjustable attachment point is configured to attach to a separate light. In some cases the adjustable attachment points are arranged in a stacked configuration.

Another aspect of the disclosed technology provides a light mounting system for a drilling rig that includes a clamp and a mounting plate. The clamp is configured to removably couple to a drilling rig support structure below the crown block of the drilling rig. The mounting plate includes an adjustable attachment point configured to attach to a light. The attachment point provides a range of motion including an operating configuration and a stowed configuration.

In various implementations the lighting mounting system includes one or more of the following features and/or aspects. In some cases the clamp includes the mounting plate and also includes a clamp plate and fasteners configured to hold the mounting plate and clamp plate together about part of the rig support structure. In some cases the adjustable attachment point includes a swivel. In some cases the adjustable attachment point includes a mounting tube attached to the mounting plate and a swivel post positioned within the mounting tube. The swivel post is configured to couple with the light. In some cases the mounting tube and swivel post each have alignment holes, and the mounting system also includes a retaining pin. The retaining pin is positioned through a mounting tube alignment hole and a swivel post alignment hole, thereby locking relative rotation of the mounting tube and swivel post. In some cases the mounting plate includes multiple adjustable attachment points. Each attachment point is configured to attach to a separate light. In some cases the adjustable attachment points are arranged in a stacked configuration.

While multiple implementations and aspects are disclosed, still other embodiments of the disclosure will become apparent to those skilled in the art from the following detailed description, which shows and describes illustrative embodiments of the disclosed apparatus, systems, and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a lighting system for a drilling rig according to various implementations.

FIG. 2 is a side view of the lighting system of FIG. 1.

FIG. 3 is a top view of the lighting system of FIG. 1 showing alternate configurations according to various implementations.

FIG. 4 is a side view of the lighting system of FIG. 1 showing a range of motion for according to various implementations.

FIG. 5 is a side view of a light mounting system for a drilling rig according to various implementations.

FIG. 6 is a perspective view of a light mounting system for a drilling rig according to various implementations.

FIG. 7 is a perspective view of a clamp mounting plate according to various implementations.

FIG. 8 is a perspective view of a swivel post for the clamp mounting plate of FIG. 7 according to various implementations.

FIG. 9 is a side view of a drilling rig and a lighting system in an operational configuration according to various implementations.

FIG. 10 is a partial side view of the drilling rig and lighting system of FIG. 9 from another side.

FIG. 11 is a top cross-sectional view of the rig and lighting system of FIG. 9 as seen from cross-section AA shown in FIG. 10.

FIG. 12 is a side view of the drilling rig and lighting system of FIG. 9 in a transport configuration according to various implementations.

FIG. 13 is a partial side view of the drilling rig and lighting system of FIG. 12 from another side.

FIG. 14 is a top cross-sectional view of the rig and lighting system of FIG. 12 as seen from cross-section BB shown in FIG. 13.

FIG. 15 is a side view of a drilling rig and a lighting system in an operational configuration according to various implementations.

FIG. 16 is a partial side view of the drilling rig and lighting system of FIG. 15 from another side.

FIG. 17 is a top cross-sectional view of the rig and lighting system of FIG. 15 as seen from cross-section CC shown in FIG. 16.

FIG. 18 is a side view of the drilling rig and lighting system of FIG. 15 in a transport configuration according to various implementations.

FIG. 19 is a partial side view of the drilling rig and lighting system of FIG. 18 from another side.

FIG. 20 is a top cross-sectional view of the rig and lighting system of FIG. 18 as seen from cross-section FF shown in FIG. 19.

### DETAILED DESCRIPTION

Implementations of the disclosed technology include lighting systems and light mounting systems for lighting a drilling rig. According to various implementations, a drilling rig lighting system includes one or more lights and a mounting system configured to attach the one or more lights to the drilling rig. The light mounting system is advantageously configured to mount the light(s) to the rig derrick or mast (also referred to herein as the rig “support structure” for convenience) below the crown block and deck. Such placement can provide enhanced illumination and visibility of the below drill site since the crown block and deck do not obstruct the path of illumination.

Various implementations further provide an adaptable and repositionable lighting system, providing flexibility for mounting one or more lights at a number of locations upon different types of rig support structures. In various cases the lighting system mounts to the rig support structure with one or more mechanical fasteners without welding. The use of mechanical fasteners, rather than welding, enables the lighting system to be installed on a wide variety of rig types without needing to identify the rig's steel material or create a weld procedure for each different rig.

In various cases a light mounting system provides multiple lighting configurations. As an example, various light mounting systems have an operating configuration in which the lights are positioned to illuminate a site, and a transport configuration in which the lights are stowed to facilitate transportation, installation, and/or removal of the rig support structure.

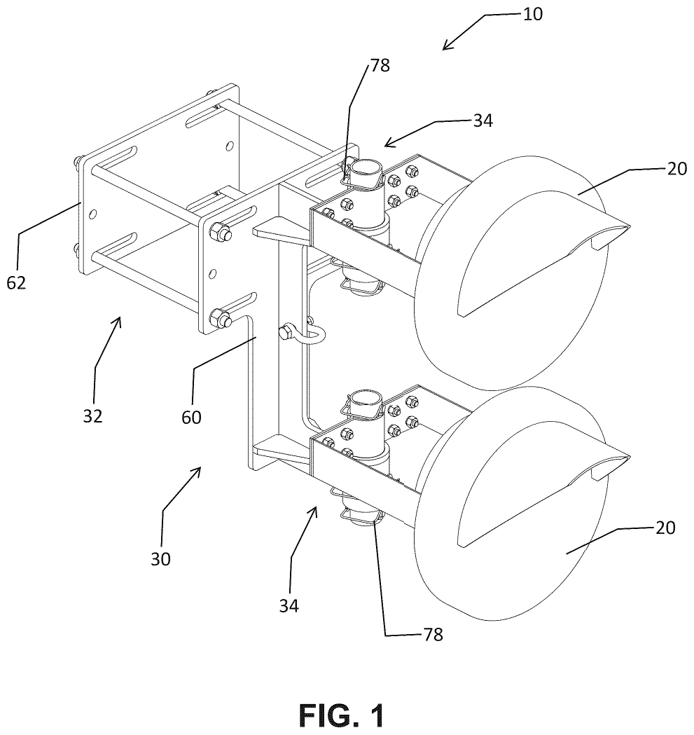

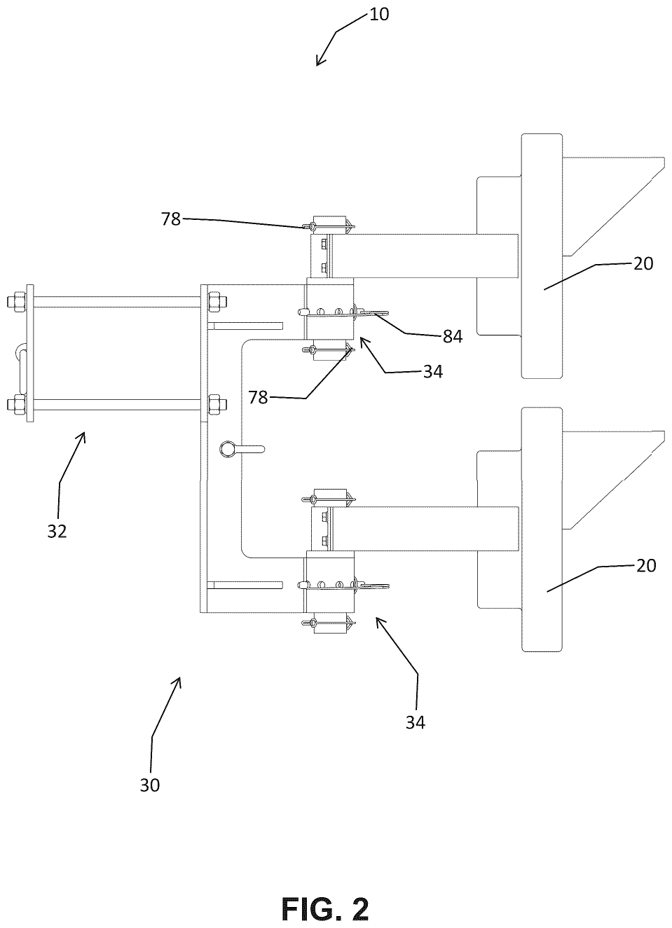

FIGS. 1 and 2 are perspective and side views, respectively, of a lighting system 10 for a drilling rig according to various implementations. In this example the lighting system 10 includes two lights 20 installed in a light mounting system 30. Various implementations may include a light mounting system with only one light or with more than two lights depending upon the desired lighting configuration. In the illustrated example the two lights are arranged in a vertical, stacked configuration, though other arrangements are possible. The lighting system 10 may include various types of lights and corresponding fixtures depending upon the desired illumination. As one possible example, in some cases the lights are flood lights with an optional visor or shroud for directionally illuminating the rig and drill site below.

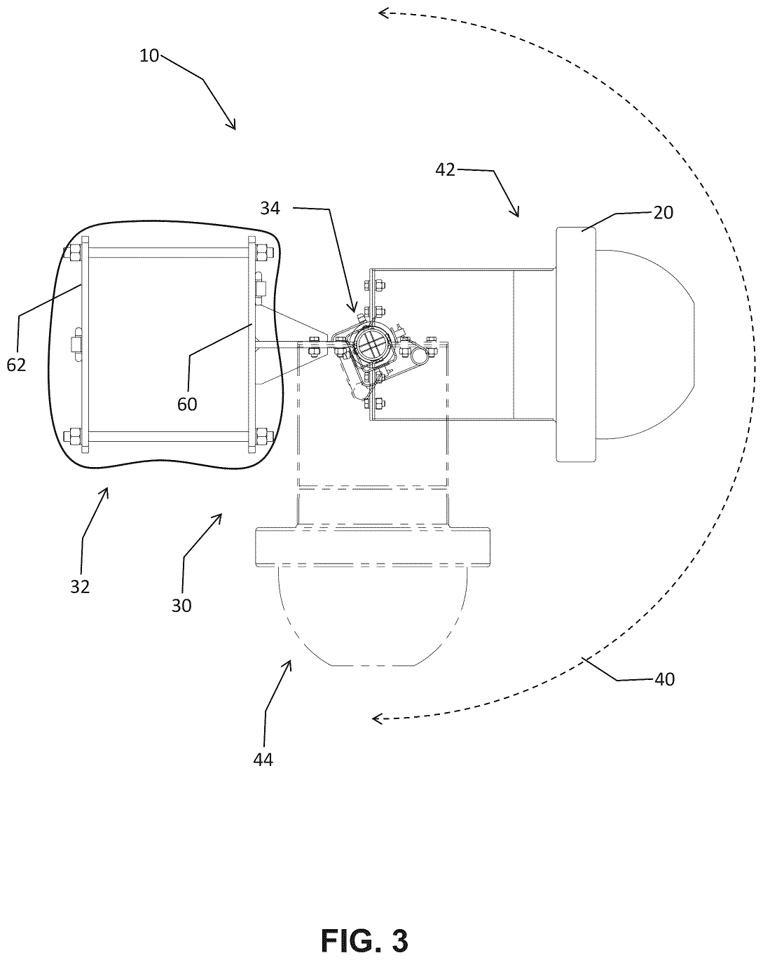

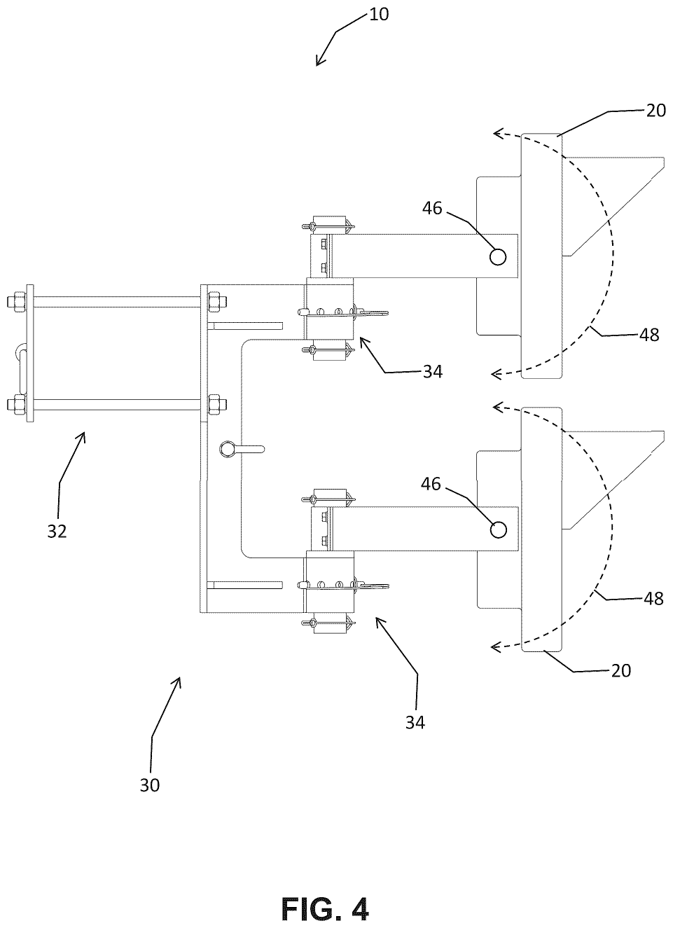

The lighting system 10 includes an attachment mechanism for attaching to the support structure of a drilling rig. In some cases the attachment mechanism includes a clamp 32 that allows the lighting system 10 to attach to various support beams of the support structure. The lighting system 10 also includes adjustable attachment points 34 for each of the lights 20. The adjustable attachment points 34 allow the lights 20 to pan side to side through a range of motion 40 as shown in FIG. 3. In various cases the range of motion includes one or more operational positions 42 and at least one stowed position 44. Various implementations of the lighting system and/or light mounting system may provide the lights 20 with one or more additional and/or alternative ranges of motion. FIG. 4 illustrates just one possible example in which each of the lights 20 rotate or pitch up and down about a pin 46 through a vertical range of motion 48.

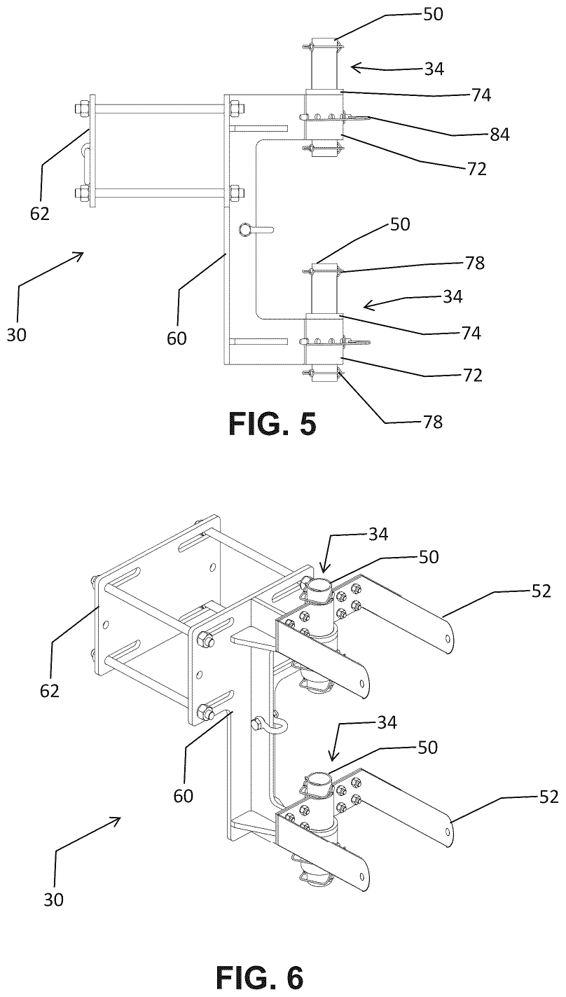

FIGS. 5 and 6 are side and perspective views, respectively, of two examples of a light mounting system 30 according to various implementations. As shown in FIG. 5, the light mounting system 30 includes attachment points 34 that in this case include swivel posts 50 that are configured to attach to a corresponding bracket of a light fixture. In the example shown in FIG. 6, the attachment points 34 include both the swivel posts 50 and attached U-brackets 52 for connecting to light fixtures. According to the disclosed technology, a light mounting system 30 can include varying degrees of structural support including a fewer or greater number of components that may in some cases be integral with a light fixture attaching to the light mounting system. As another example, in some cases a light mounting system similar to the system 30 of FIG. 5 does not include swivel posts 50, but has attachment points 34 that are adapted to receive similar posts that are integral with connecting light fixtures.

As shown in the illustrated examples, in some cases the light mounting system 30 includes an attachment mechanism in the form of a clamp 32 that allows the system 30 to be removably attached to a rig support structure. In various implementations the clamp 32 includes a front clamp plate 60, a back clamp plate 62, and fasteners such as threaded studs or bolts, washers, and nuts that removably secure the front and back clamp plates 60, 62 about a beam of the rig support structure. According to various implementations, the clamp 32 allows the light mounting system 30 to be removably attached to a derrick or mast below the crown block. As shown in the drawings, the clamp 32 has a rectangular configuration in these implementations that is adapted to hold to a support beam with a rectangular cross-section. In various cases the clamp 32 is configured to attach the light mounting system 30 below the crown block to one of the four vertical corner beams of the support structure.

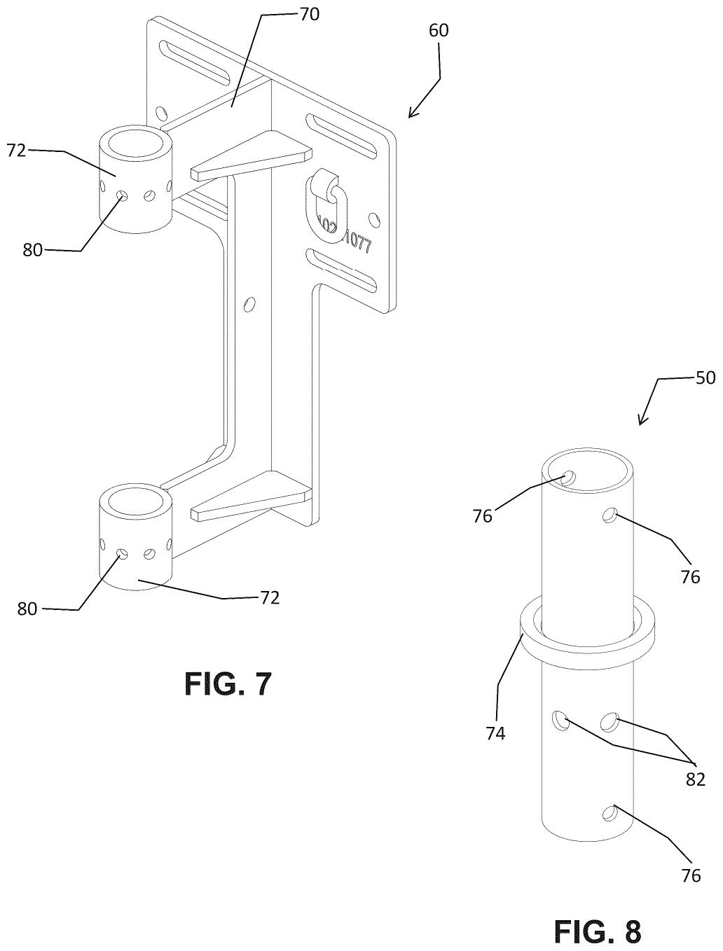

FIG. 7 is a perspective view of a front clamp plate or clamp mounting plate 60 according to various implementations. The front clamp plate 60 in this example includes a mounting plate 70 attached to two mounting tubes 72. The mounting tubes 72 are configured to receive the swivel posts 50, which are also illustrated in the perspective view of FIG. 8. Each swivel post 50 includes a resting ring 74 attached (e.g., welded) about the post 50. As shown in FIGS. 1, 2, 5, and 6, the resting ring 74 rests upon the upper surface of the mounting tube 72 when the swivel post 50 is placed in the mounting tube 72. In various implementations the swivel posts 50 include holes 76 near the top and/or bottom of the posts. Retaining pins 78 (e.g., clevis pins with wire retainers) inserted through the holes 76 help retain the swivel posts within the mounting tubes 72 when the light 20 and mounting bracket 52 is attached to the swivel post 50 as shown in FIGS. 1, 2, and 6.

According to various implementations, the mounting tubes 72 include alignment holes 80 that correspond to alignment holes 82 in the swivel posts 50. The holes 80, 82 are configured to receive a retaining pin 84 (e.g., clevis pin) that rotationally fixes the swivel post 50 within the mounting tube 72. In some cases the light 20 is fixedly attached to the swivel post 50 through, e.g., a friction fit, weld, or other temporary or permanent fixation. In such cases, the retaining pin 84 and holes can be used to lock the orientation of the light in, for example, an operating position or configuration or a stowed position/configuration.

The angle and alignment of the holes 80, 82 can vary depending upon the orientations that are desired. In various implementations the holes 80 in the mounting tube 72 are spaced apart by 45 degrees. In various implementations the holes 82 in the swivel posts 50 are spaced apart by 67.5 degrees. Other angular separations are also possible. In some cases the alignment holes are useful for limiting the available range of motion 40 for the lighting system 10. As an example, the alignment holes and retaining pin 84 can be used to prevent a light from swinging into part of the rig structural support, such as a ladder 102 as shown in FIGS. 14 and 20.

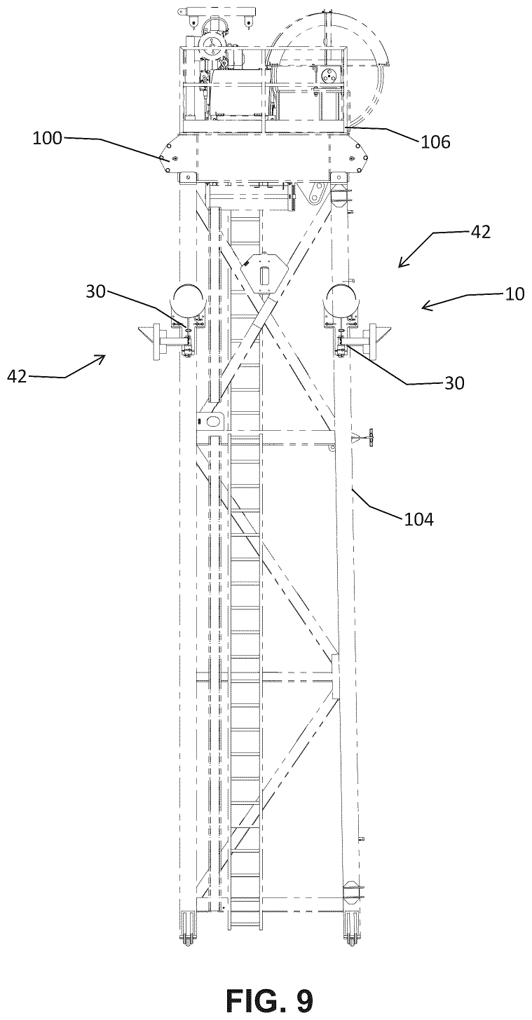

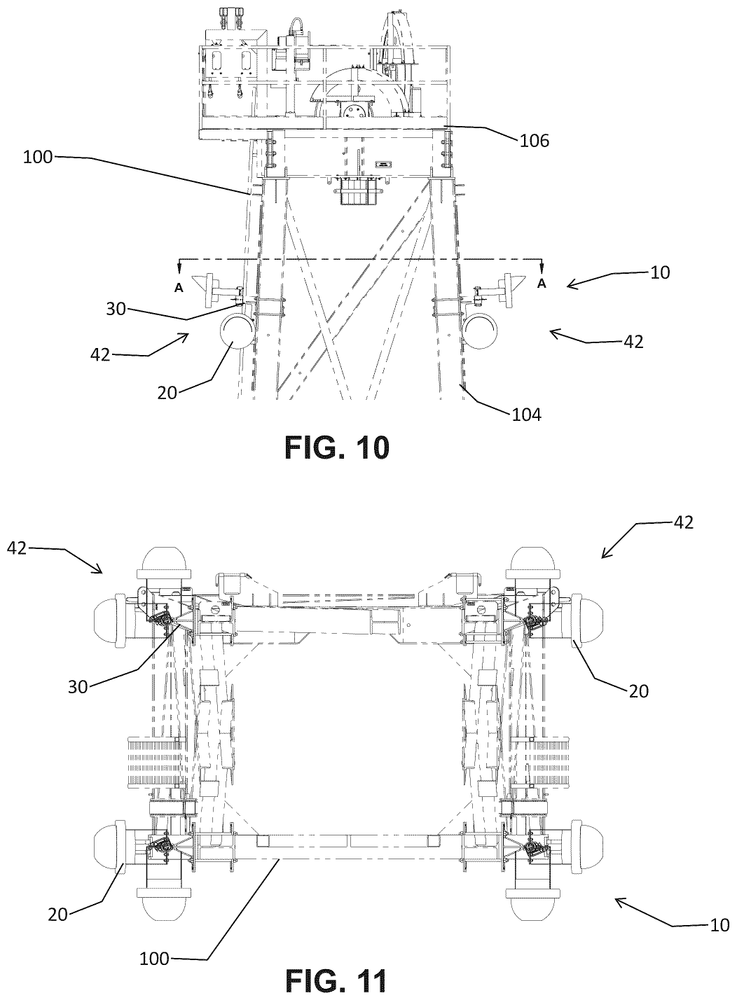

FIGS. 9-11 are various views of a drilling rig 100 and lighting system 10 in an operational configuration according to various implementations. FIG. 9 is a side view of the drilling rig 100 and the lighting system 10 and FIG. 10 is a partial side view of the drilling rig and lighting system from another side. FIG. 11 is a top cross-sectional view of the rig and lighting system as seen from cross-section AA shown in FIG. 10.

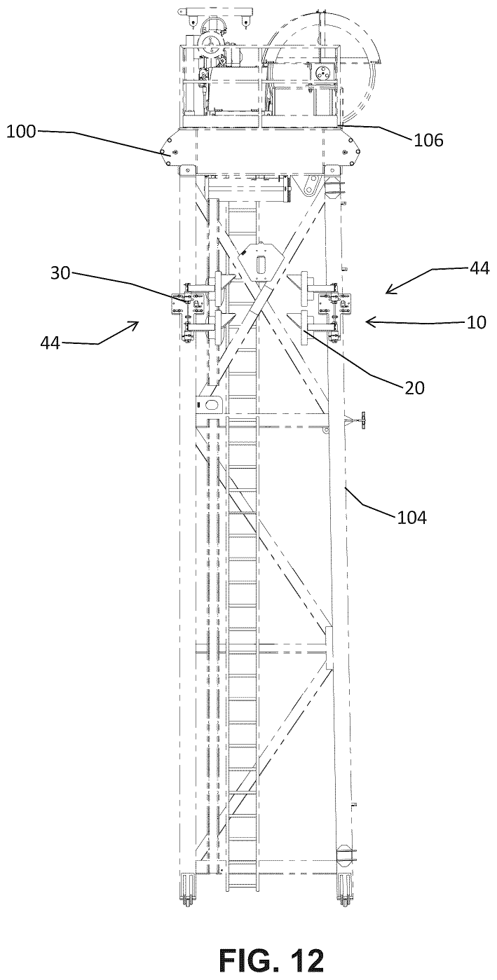

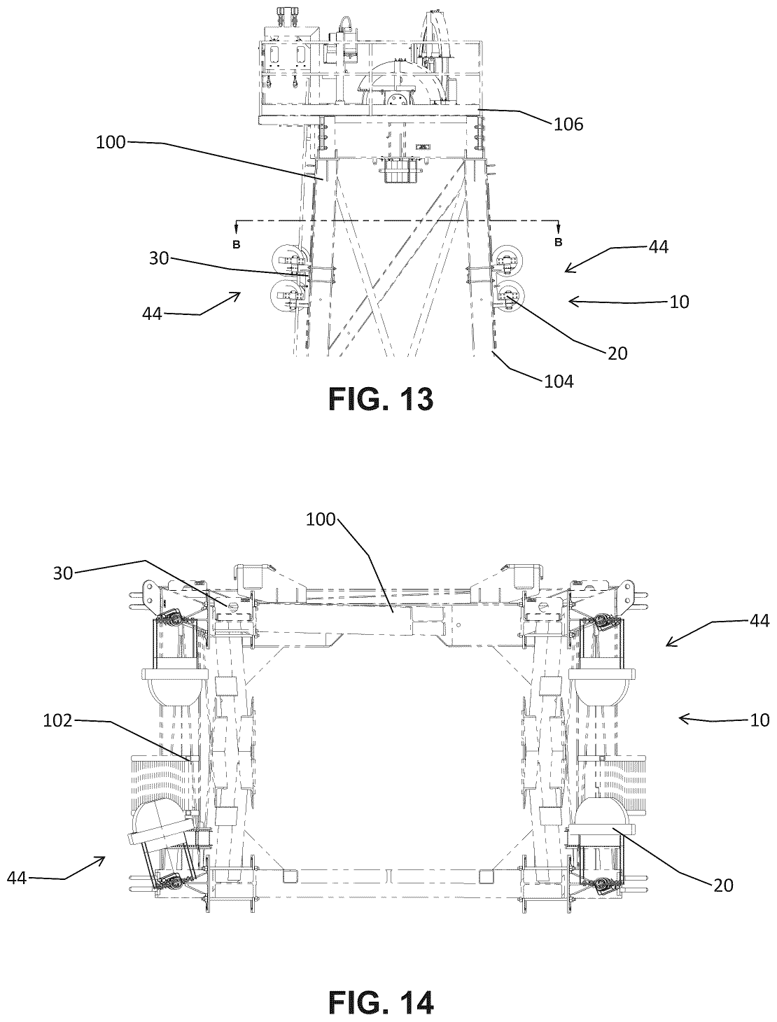

Turning to FIGS. 12-14, a stowed configuration of the lighting system 10 mounted to the rig 100 is shown according to various implementations. FIG. 12 is a side view of the drilling rig 100 and the lighting system 10 and FIG. 13 is a partial side view of the drilling rig and lighting system from another side. FIG. 14 is a top cross-sectional view of the rig and lighting system as seen from cross-section BB shown in FIG. 13.

As can be seen in FIGS. 9-14, the lighting system 10 in this example includes multiple lights 20 mounted to the drilling rig 100 with multiple light mounting systems 30. A different number of mounting systems and/or lights may be included in the lighting system 10 in various implementations. In this example four light mounting systems 30 are used to mount eight lights 20 to the rig. In this case each light mounting system 30 is clamped to a vertically extending support beam 104 at one of the corners of the rig's support structure. FIGS. 9-11 illustrate how each of the lights 20 of the lighting system 10 can be positioned below the crown deck 106 in a different operating orientation 42, extending away from the support structure. FIGS. 12-14 illustrate a stowed or transport configuration 44 in which each of the lights are positioned (e.g., folded) inward toward the rig's support structure, thus making the rig easier to transport.

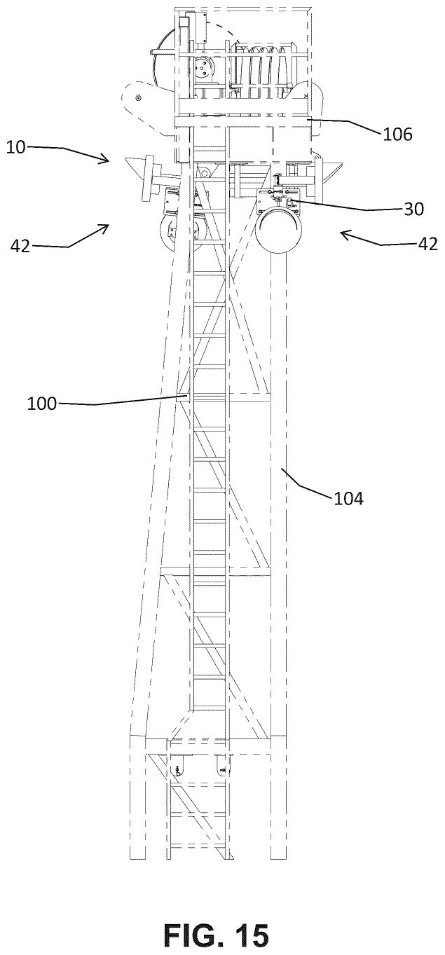

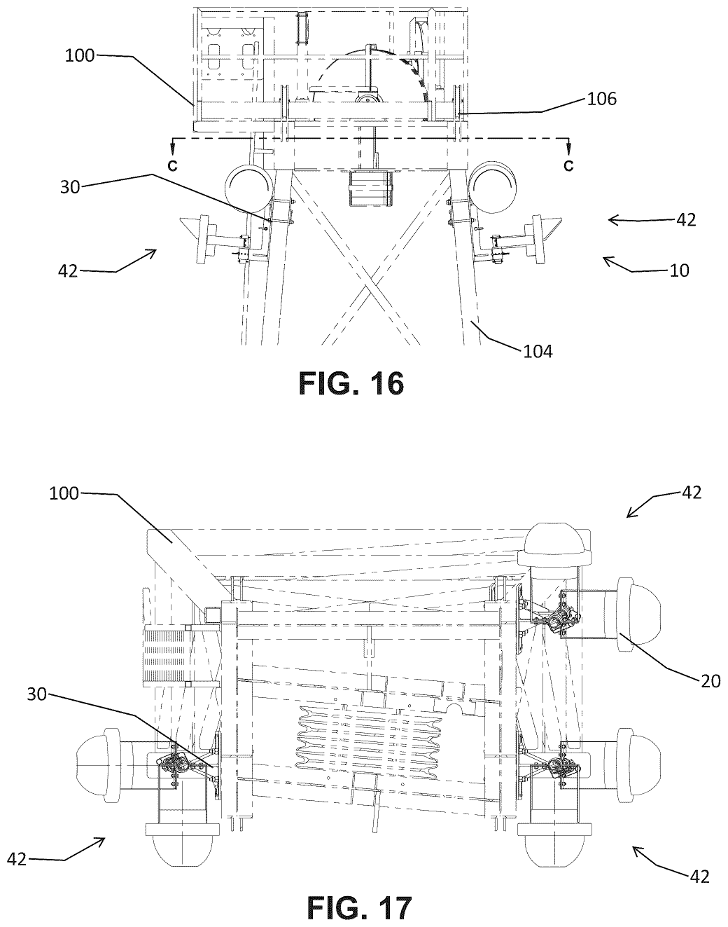

FIGS. 15-17 are various views of another drilling rig 100 and a lighting system 10 in an operational configuration 42 according to various implementations. FIG. 15 is a side view of a drilling rig 100 and the lighting system 10 and FIG. 16 is a partial side view of the drilling rig and lighting system from another side. FIG. 17 is a top cross-sectional view of the rig and lighting system as seen from cross-section CC shown in FIG. 16.

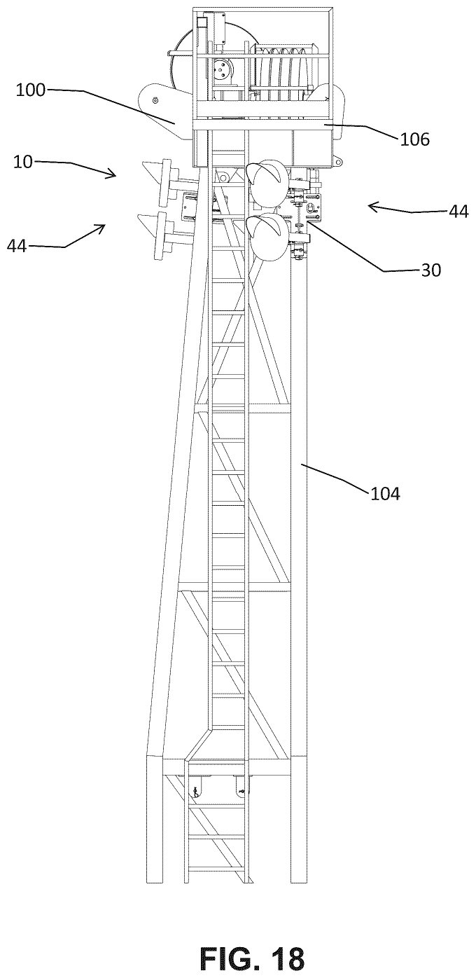

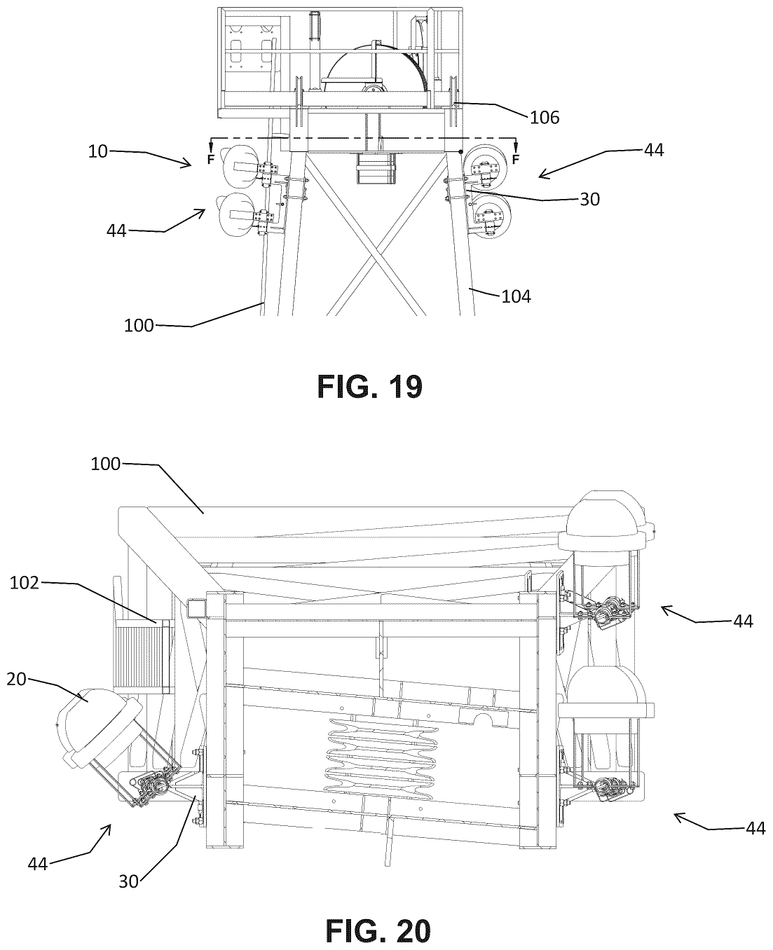

FIGS. 18-20 depict the rig 100 and lighting system 10 of FIGS. 15-17, now in a stowed configuration 44 according to various implementations. FIG. 18 is a side view of the drilling rig 100 and the lighting system 10 and FIG. 19 is a partial side view of the drilling rig and lighting system from another side. FIG. 20 is a top cross-sectional view of the rig and lighting system as seen from cross-section FF shown in FIG. 19.

As can be seen in FIGS. 15-20, the lighting system 10 in this example includes six lights 20 mounted to the drilling rig 100 with three light mounting systems 30. A different number of mounting systems and/or lights may be included in the lighting system 10 in various implementations. In this case each light mounting system 30 is clamped to a vertically extending support beam 104 at one of the corners of the rig's support structure. FIGS. 15-17 illustrate how each of the lights 20 of the lighting system 10 can be positioned below the crown deck 106 in a different operating orientation 42, extending away from the support structure. FIGS. 18-20 illustrate a stowed or transport configuration 44 in which each of the lights are positioned (e.g., folded) inward toward the rig's support structure, thus making the rig easier to transport.

Although the disclosure has been described with reference to certain implementations and embodiments, persons skilled in the art will recognize that changes may be made in form and detail without departing from the spirit and scope of the disclosed apparatus, systems, and methods.

What is claimed is:

1. A lighting system for a drilling rig, comprising:
a light mounting system comprising:
an attachment mechanism configured to removably couple to a support structure of a drilling rig below the crown block, and
an adjustable attachment point coupled with the attachment mechanism; and
a light attached to the adjustable attachment point.

2. The lighting system of claim 1, wherein the adjustable attachment point provides the light with a range of motion comprising an operating configuration and a stowed configuration.

3. The lighting system of claim 1, wherein the light mounting system comprises a plurality of adjustable attachment points coupled to the attachment mechanism, and further comprising a plurality of lights, each light attached to one of the plurality of adjustable attachment points.

4. The lighting system of claim 3, wherein the adjustable attachment points are arranged in a stacked configuration.

5. The lighting system of claim 1, wherein the attachment mechanism comprises a mounting plate coupled with the adjustable attachment point, a clamp plate, and fasteners configured to hold the mounting plate and clamp plate together about part of the support structure.

6. A light mounting system for a drilling rig, comprising:
an attachment mechanism configured to removably couple to a support structure of a drilling rig; and
an adjustable attachment point coupled with the attachment mechanism, the adjustable attachment point configured to attach to a light for positioning the light below the crown block of the drilling rig.

7. The light mounting system of claim 6, wherein the adjustable attachment point provides an attached light with a range of motion comprising an operating configuration and a stowed configuration.

8. The lighting mounting system of claim 6, further comprising a plurality of adjustable attachment points coupled to the attachment mechanism, each adjustable attachment point configured to attach to one of a plurality of lights.

9. The lighting system of claim 8, wherein the adjustable attachment points are arranged in a stacked configuration.

10. The lighting system of claim 6, wherein the attachment mechanism comprises a mounting plate coupled with the adjustable attachment point, a clamp plate, and fasteners configured to hold the mounting plate and clamp plate together about part of the support structure.

11. A light mounting system for a drilling rig, comprising:
a clamp configured to removably couple to a drilling rig support structure below the crown block of the drilling rig; and
a mounting plate comprising an adjustable attachment point configured to attach to a light, the attachment point comprising a range of motion comprising an operating configuration and a stowed configuration.

12. The light mounting system of claim 11, wherein the clamp comprises the mounting plate and further comprises a clamp plate and fasteners configured to hold the mounting plate and clamp plate together about part of the rig support structure.

13. The light mounting system of claim 12, wherein the adjustable attachment point comprises a swivel.

14. The light mounting system of claim 13, wherein the adjustable attachment point comprises a mounting tube attached to the mounting plate and a swivel post positioned within the mounting tube, the swivel post configured to couple with the light.

15. The light mounting system of claim 14, wherein the mounting tube and swivel post each comprise alignment holes, and further comprising a retaining pin positioned through a mounting tube alignment hole and a swivel post alignment hole, thereby locking relative rotation of the mounting tube and swivel post.

16. The light mounting system of claim 11, wherein the mounting plate comprises a plurality of adjustable attachment points, each attachment point configured to attach to one of a plurality of lights.

17. The light mounting system of claim 16, wherein the adjustable attachment points are arranged in a stacked configuration.
